(19) United States
(12) Patent Application Publication
(10) Pub. No.: US 2026/0094018 A1
(43) Pub. Date: Apr. 2, 2026

(54) GENERATION METHOD, COMPUTER-READABLE RECORDING MEDIUM, AND INFORMATION PROCESSING DEVICE

(71) Applicant: Fujitsu Limited, Kawasaki-shi (JP)

(72) Inventor: Tatsuru MATSUO, Kawasaki (JP)

(73) Assignee: Fujitsu Limited, Kawasaki-shi (JP)

(21) Appl. No.: 19/330,896

(22) Filed: Sep. 17, 2025

(30) Foreign Application Priority Data
Sep. 27, 2024 (JP) 2024-168253

(51) Int. Cl. G06N 5/022

(52) U.S. Cl. CPC G06N 5/022

(57) ABSTRACT

A generation method includes, selecting a first entity from a first knowledge graph that includes a plurality of the first entities indicating events connected by a cause-result relation based on a first input document, generating a second knowledge graph that includes a second entity indicating each of events connected by a cause-result relation included in a second input document, that is related to the first entity, based on the selected first entity and the second input document, and generating a third knowledge graph by connecting the first knowledge graph and the second knowledge graph by processor.

This application is based upon and claims the benefit of priority of the prior Japanese Patent Application No. 2024-168253, filed on September 27, 2024, the entire contents of which are incorporated herein by reference.

### FIELD

The embodiments discussed herein are related to a generation method, a computer-readable recording medium, and an information processing device.

### BACKGROUND

In recent years, to deal with virtualization and multi-vendors, the configuration of information technology (IT) has become complex, and the fault causes have been diversified. For example, in an IT system including multi-vendor radio units (RUs) and distributed units (DUs), a fault may occur when an RU of a new vendor is added and connected to the existing DU. In the fault cause analysis of such a case, wide variety of separations and analyses may be performed. For example, in the fault cause analysis, faults may be classified into various types such as a hardware failure, a compatibility problem between RUs and DUs, a compatibility problem between RU switches and DU switches, and identifier (ID) misconfiguration, and each of the faults will be examined.

However, if the fault cause analysis that has become complex in this manner is executed by relying on the experience and knowledge of analysts, it is time consuming and it is not clear whether the analysis is correct. Hence, it is sometimes difficult to perform appropriate fault cause analysis. Therefore, to operate IT systems and networks in a stable manner, it is important to develop fault cause analysis techniques that can speed up the fault recovery. For example, in a large-scale network or the like, the fault location specification and the fault cause analysis are both important. However, in this example, the main focus will be on the fault cause analysis.

For example, as a fault cause analysis technique, a technique that obtains the fault cause from a fault case document such as a fault report or from a non-fault case document such as a specification as a response, using a large language model (LLM), has been developed. In this technique, the fault cause is estimated on the basis of a specific document given to the input fault, and the estimated result is provided as a response.

Moreover, defect diagnosis techniques include the following techniques. For example, when the degree of semantic similarity between the knowledge item included in a first knowledge graph that is defect related graph information and the knowledge item included in a second knowledge graph based on different domain knowledge satisfies the condition, there is a technique for generating an integrated graph of the first knowledge graph and the second knowledge graph.

However, in a conventional technique that generates a response based on a specific document using the LLM, the response is provided based on a single document. Hence, the response performance may be low. For example, a fault case document is often a document that describes one fault that has actually occurred. Hence, it is difficult for the LLM to provide a response for a fault that has not yet occurred on the basis of one fault case document. Moreover, because the non-fault case document such as a specification is not a document for describing fault cases, fault causality is often not clearly indicated. Therefore, the amount of information on the fault causality obtained by referring to the non-fault case document alone is small, and it is difficult for the LLM to provide a response for a fault that has not yet occurred, on the basis of one non-fault case document. In this manner, in the conventional technique that generates a response on the basis of a specific document using the LLM, it is difficult to provide a response for the fault causality identified by comprehensively referring to a plurality of documents. Hence, it is difficult to improve the response performance.

Moreover, in the technique of generating an integrated graph if the degree of semantic similarity satisfies the condition, the integrated graph is generated from the knowledge graphs obtained from each of independent documents. Hence, it is not known whether information on the same fault is included in both documents. Then, even if words related to defect are to be extracted from a document other than the document written on faults, there are often omissions, and it is unlikely that appropriate results can be obtained. Moreover, in this technique, an integrated graph for obtaining new fault causality of the specific fault is not generated. Therefore, even when this technique is used, it is difficult to obtain new fault causality of the specific fault. Hence, it is difficult to improve the response performance.

### SUMMARY

According to an aspect of an embodiment, a generation method includes, selecting a first entity from a first knowledge graph that includes a plurality of the first entities indicating events connected by a cause-result relation based on a first input document, generating a second knowledge graph that includes a second entity indicating each of events connected by a cause-result relation included in a second input document, that is related to the first entity, based on the selected first entity and the second input document, and generating a third knowledge graph by connecting the first knowledge graph and the second knowledge graph by processor.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram of an information processing device according to a first embodiment;

FIG. 2 is a diagram illustrating an example of a fault case document and an actual fault knowledge graph;

FIG. 3 is a diagram illustrating an example of data representation of the actual fault knowledge graph;

FIG. 4 is a diagram illustrating an example of a non-fault case document and a virtual fault knowledge graph;

FIG. 5 is a diagram illustrating an outline of processing performed by the information processing device;

FIG. 6 is a diagram for explaining an example of a prompt option;

FIG. 7 is a diagram illustrating an example of a connection method between the actual fault knowledge graph and the virtual fault knowledge graph;

FIG. 8 is a diagram illustrating a specific image of connecting the actual fault knowledge graph and the virtual fault knowledge graph;

FIG. 9 is a diagram illustrating a connected pattern when the connection origin and the connection destination are both fault entities;

FIG. 10 is a diagram illustrating a connected pattern when the connection origin and the connection destination are both fault-causing entities;

FIG. 11 is a diagram illustrating a connected pattern when the entity of the connection origin is an intermediate event entity, and the entity of the connection destination is a fault-causing entity or a fault entity;

FIG. 12 is a flowchart of a generation process of a connected knowledge graph by the information processing device according to the first embodiment;

FIG. 13 is a diagram for explaining the effects of generating the connected knowledge graph;

FIG. 14 is a block diagram of an information processing device according to a second embodiment;

FIG. 15 is a diagram illustrating an example of information held by the information processing device according to the second embodiment;

FIG. 16 is a diagram illustrating the generation of a virtual fault knowledge graph by the information processing device according to the second embodiment;

FIG. 17 is a flowchart of a generation process of a connected knowledge graph by an information processing device according to a third embodiment; and

FIG. 18 is a hardware configuration diagram of the information processing device.

### DESCRIPTION OF EMBODIMENTS

Preferred embodiments of the present invention will be explained with reference to accompanying drawings. However, the generation method, the generation program, and the information processing device disclosed in the present application are not limited by the following embodiments.

### (a) First Embodiment

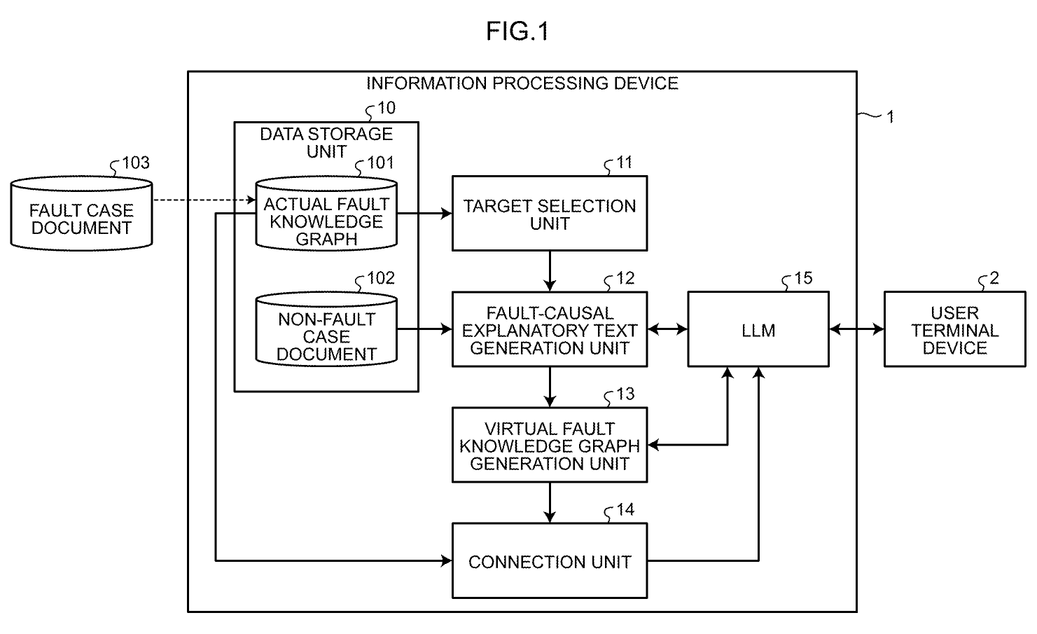

FIG. 1 is a block diagram of an information processing device according to a first embodiment. An information processing device 1 obtains the fault content of a fault that has actually occurred from a user terminal device 2, and provides a response by estimating the fault cause. As illustrated in FIG. 1, the information processing device 1 includes a data storage unit 10, a target selection unit 11, a fault-causal explanatory text generation unit 12, a virtual fault knowledge graph generation unit 13, a connection unit 14, and an LLM 15.

For example, the data storage unit 10 holds in advance one or more actual fault knowledge graphs 101 and one or more non-fault case documents 102 input from an external device.

The actual fault knowledge graph 101 is a knowledge graph generated from a fault case document 103. FIG. 1 illustrates that the actual fault knowledge graph 101 is generated from the fault case document 103, by illustrating an arrow that extends from the external fault case document 103 to the actual fault knowledge graph 101. The fault case document 103 is a document such as a fault handling report in a report format that describes the fault content of an actual fault that has actually occurred and the fault cause.

In this example, the knowledge graph is a graph that indicates a knowledge network in which events related to an actual fault that is a fault having occurred are successively connected by a causal relation for associating each event. The actual fault is also included in one event. In the knowledge graph, each event is represented as an entity. Moreover, the causal relation between the events is represented as an edge. By connecting the entities with an edge, the knowledge graph is represented in a format that indicates the mutual relation. An entity serving as the starting point of the causal relation in the actual fault knowledge graph 101 generated from the fault case document 103 indicates an event corresponding to the primary fault cause, and an entity serving as the end point of the causal relation indicates an event corresponding to the fault that finally occurs. In the following, the fault that finally occurs is referred to as an "occurred fault".

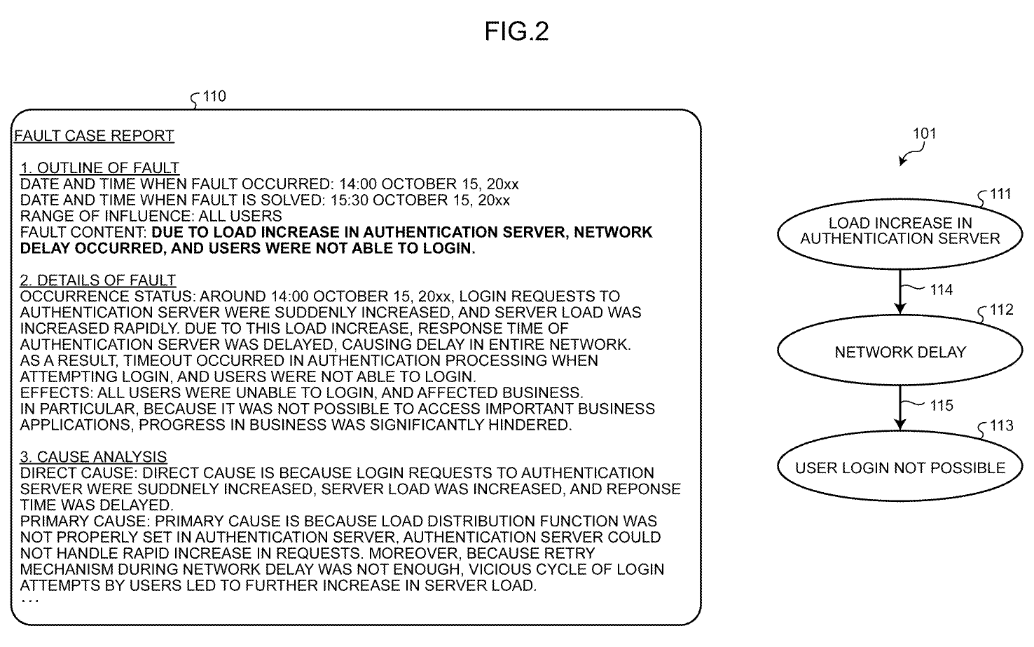

FIG. 2 is a diagram illustrating an example of a fault case document and an actual fault knowledge graph. A fault case report 110 corresponds to an example of the fault case document 103. Then, in the description of the fault case report 110, the fault content indicates the actual fault. An event of "user login not possible" described in the fault content is an event indicated by an entity 113 corresponding to the occurred fault in the actual fault knowledge graph 101. Then, an event of "load increase in the authentication server" described in the details of the fault and the cause analysis, is an event indicated by an entity 111 corresponding to the fault cause in the actual fault knowledge graph 101. Furthermore, from the details of the fault and the cause analysis, a network delay is specified as an event that occurs between the load increase in the authentication server that is the fault cause, and the user login not possible that is the occurred fault. The network delay is an event that is present in the middle of the causal relation leading to the occurred fault from the fault cause, and is indicated by an entity 112. In the following, an event that is present in the middle of the causal relation leading to the occurred fault from the fault cause is referred to as an intermediate event.

The entity 111 and the entity 113 are linked by a causal relation via the entity 112 indicating the intermediate event. Thus, in the actual fault knowledge graph 101, the entity 111 and the entity 112 are connected by an edge 114 indicating a causal relation, and the entity 112 and the entity 113 are connected by an edge 115 indicating a causal relation. In this process, the edges 114 and 115 are indicated by arrows that extend from cause to result. An event treated as one type of the fault cause, the intermediate event, and the occurred fault in the actual fault knowledge graph 101 of the specified fault case document 103 may be treated as a different type in the actual fault knowledge graph 101 of another fault case document 103.

In this process, in the actual fault knowledge graph 101 of FIG. 2, the fault cause, the intermediate event, and the occurred fault are represented by a single line. However, in the actual fault knowledge graph 101, there may be a plurality of the fault causes and intermediate events for one occurred fault. Hence, the edge linked to the fault cause from the occurred fault may be branched at any intermediate event according to the causal relation.

In the following, an entity indicating the fault cause such as the entity 111 in the actual fault knowledge graph 101 is referred to as a fault-causing entity. Moreover, an entity indicating the intermediate event such as the entity 112 in the actual fault knowledge graph 101 is referred to as an intermediate event entity. Moreover, an entity indicating the occurred fault such as the entity 113 in the actual fault knowledge graph 101 is referred to as a fault entity. Moreover, if the fault-causing entity, the intermediate event entity, and the fault entity need not be distinguished from each other, the fault-causing entity, the intermediate event entity, and the fault entity are simply referred to as an entity.

The actual fault knowledge graph 101 may be created manually from the fault case document 103, or may be created automatically from the fault case document 103 using an external LLM or the like. Moreover, in the present embodiment, the actual fault knowledge graph 101 is described as information created in advance. However, in addition, the information processing device 1 may generate the actual fault knowledge graph 101 from the fault case document 103 using the LLM 15. Moreover, one or a plurality of the actual fault knowledge graphs 101 may be generated from one fault case document 103.

In this process, the actual fault knowledge graph 101 is conceptually represented as a graph in FIG. 2. However, in practice, the information processing device 1 identifies the information in the actual fault knowledge graph 101 with data representation of a combination of an entity and an edge. For example, the data storage unit 10 holds a list of data indicating a combination of an entity and an edge representing the actual fault knowledge graph 101.

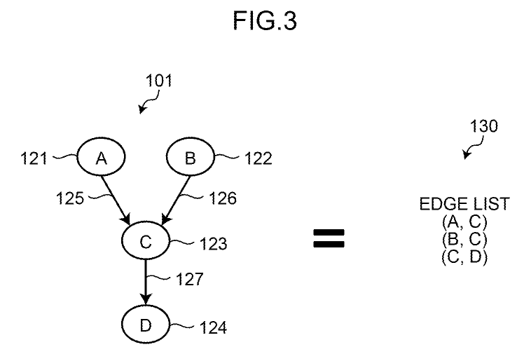

FIG. 3 is a diagram illustrating an example of data representation of the actual fault knowledge graph. For example, the actual fault knowledge graph 101 including entities 121 to 124 and edges 125 to 127 will be described. A to D described in the entities 121 to 124 are events indicated by the entities 121 to 124.

The data storage unit 10 holds an edge list 130 as data indicating the actual fault knowledge graph 101 in FIG. 3. The edge list 130 is a list of edge representations that indicates a combination of an entity and an edge. The edge representation of (A, C) represents that an event A and an event C have a causal relation in which the event A is the cause and the event C is the result. That is, the edge representation of (A, C) is information indicating that the entity 121 indicating the event A and the entity 123 indicating the event C, are connected by the edge 125 extending from the entity 121 to the entity 123. Similarly, the edge representation of (B, C) and the edge representation of (C, D) in the edge list 130 are also information indicating the relation between each of the entities and edges. In this process, the arrangement order of the edge representations in the edge list 130 is not limited. Moreover, the events A to D may be described as they are. Alternatively, identification information may be allocated to each of the events to be held, and the identification information indicating each of the events may be used as the events A to D.

Returning to FIG. 1, the description will continue. For example, the non-fault case document 102 is a general document including specifications, technical papers, and the like. However, as will be described below, because the content related to the occurred fault serving as a target is extracted from the non-fault case document 102, the non-fault case document 102 is preferably a document including a description on the actual fault described in the fault case document 103.

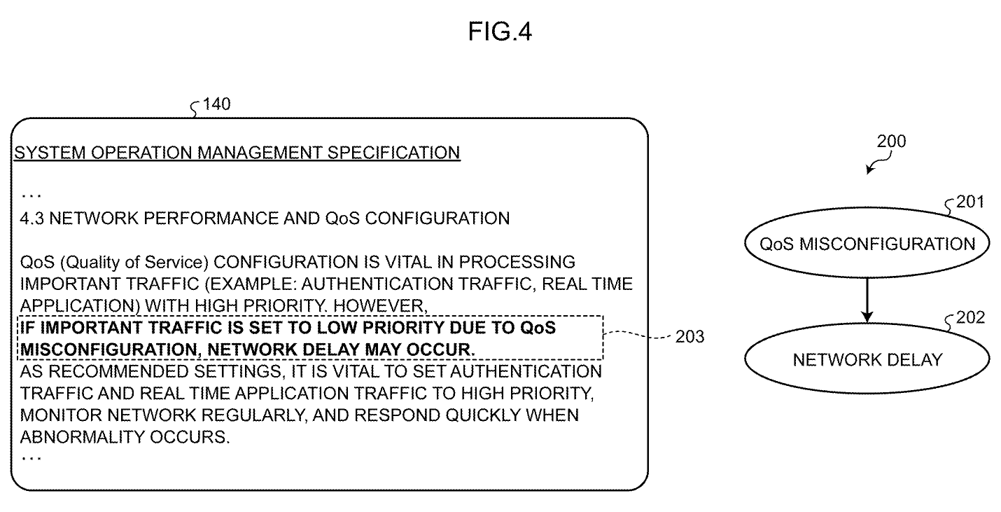

FIG. 4 is a diagram illustrating an example of a non-fault case document and a virtual fault knowledge graph. A system operation management specification 140 illustrated in FIG. 4 corresponds to an example of the non-fault case document 102. The system operation management specification 140 is a document including information on an event generated by a system operation, and may be a document including information on the occurred fault serving as a target. A virtual fault knowledge graph 200 is data for generating a knowledge graph related to the actual fault knowledge graph 101, and is a knowledge graph generated from the non-fault case document 102. The details will be described below.

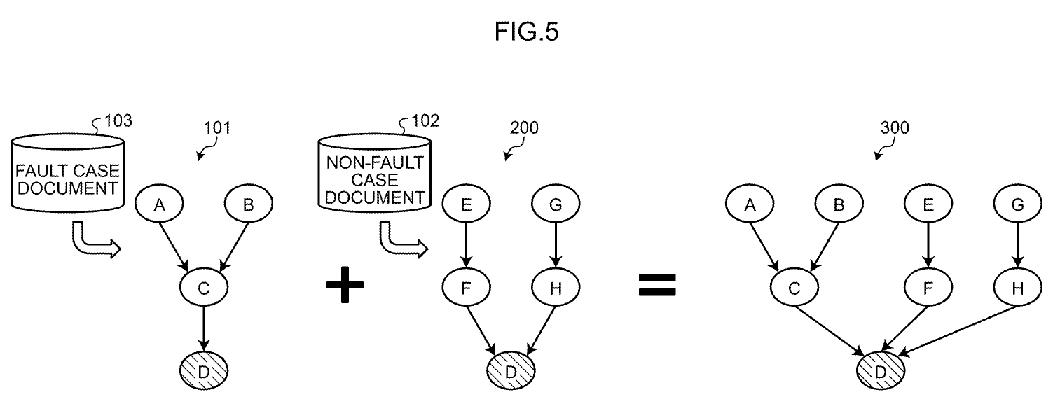

In this process, to make the following explanation easier to understand, with reference to FIG. 5, an outline of processing performed by the information processing device 1 according to the first embodiment will be briefly described. FIG. 5 is a diagram illustrating an outline of processing performed by the information processing device.

The information processing device 1 holds the actual fault knowledge graph 101 generated from the fault case document 103 as described above. Moreover, from the content described in the non-fault case document 102, the information processing device 1 generates the virtual fault knowledge graph 200 indicating a causal relation between the fault cause and the occurred fault. Then, the information processing device 1 generates a new connected knowledge graph 300, by connecting the actual fault knowledge graph 101 and the virtual fault knowledge graph 200. The new connected knowledge graph 300 includes information on the causal relation between the occurred fault obtained from the non-fault case document 102 and the other fault cause, in addition to the actual fault knowledge graph 101. Therefore, by using the connected knowledge graph 300, the information processing device 1 can estimate the fault cause while taking into account the fault case document 103 and the non-fault case document 102, for the query on the fault from a user. Hence, it is possible to improve the response performance. Hereinafter, processing performed by the information processing device 1 will be described in detail.

Returning to FIG. 1, the description will continue. When the data storage unit 10 holds a plurality of the actual fault knowledge graphs 101, the target selection unit 11 performs the following processing on each of the actual fault knowledge graphs 101.

The target selection unit 11 selects the target entity serving as a connection origin one at a time, from the entities included in the actual fault knowledge graph 101. The connection origin is an entity serving as a connection point in the actual fault knowledge graph 101, when the connected knowledge graph 300 is created by connecting the actual fault knowledge graph 101 and the virtual fault knowledge graph 200 created from the non-fault case document 102. Subsequently, the target selection unit 11 outputs information on the selected target entity to the fault-causal explanatory text generation unit 12.

In this process, the target selection unit 11 may select the target entity one at a time from all the entities included in the actual fault knowledge graph 101, or may select the target entity one at a time from the limited types of entities. For example, by using an edge list as follows, the target selection unit 11 can select the target entity by each type.

In the example, the edge list 130 in FIG. 3 will be used for explanation. By selecting the entity that only appears on the left side of the edge representation included in the edge list 130, the target selection unit 11 can select the fault-causing entity as the target entity. For example, in the edge list 130, events that only appear on the left side of the edge representation are events A and B. Therefore, when selecting a fault-causing entity from the edge list 130, the target selection unit 11 selects the event A and the event B as the target entities.

Moreover, by selecting the entity that only appears on the right side of the edge representation included in the edge list 130, the target selection unit 11 can select the fault entity as the target entity. For example, in the edge list 130, the event that only appears on the right side of the edge representation is an event D. Therefore, when selecting a fault entity from the edge list 130, the target selection unit 11 selects the event D as the target entity.

Moreover, by selecting the entity that appears on both sides of the edge representation included in the edge list 130, the target selection unit 11 can select the intermediate event entity as the target entity. For example, in the edge list 130, the event that appears on both sides of the edge representation is the event C. Therefore, when selecting an intermediate event entity from the edge list 130, the target selection unit 11 selects the event C as the target entity. In the example, the selection method by each type is illustrated. However, by combining the selection methods, the target selection unit 11 can select the target entity across multiple types.

This fault case document 103 corresponds to an example of a "first input document", the actual fault knowledge graph 101 corresponds to an example of a "first knowledge graph", and the entity included in the actual fault knowledge graph 101 corresponds to an example of a "first entity". That is, the target selection unit 11 selects the first entity from the first knowledge graph that includes a plurality of the first entities indicating events connected by a cause-result relation on the basis of the first input document. Moreover, the target selection unit 11 may select one entity included in the first knowledge graph.

Moreover, the first entity includes the fault entity indicating an event when the actual fault has occurred, the fault-causing entity indicating an event serving as the fault cause, and the intermediate event entity indicating an event that occurs between the actual fault and the fault cause. Then, from the first entities, the target selection unit 11 can select one or a combination of the fault entity, the fault-causing entity, and the intermediate event entity.

Returning to FIG. 1, the description will continue. The fault-causal explanatory text generation unit 12 receives input of information on the target entity from the target selection unit 11. Then, the fault-causal explanatory text generation unit 12 generates a fault-causal explanatory text for explaining a causal relation between the fault cause and the occurred fault related to the target entity, using the non-fault case document 102.

For example, depending on whether the target entity is the fault cause or whether the target entity is the occurred fault, the fault-causal explanatory text generation unit 12 generates a prompt to generate a fault-causal explanatory text related to the target entity on the basis of the non-fault case document 102. Then, the fault-causal explanatory text generation unit 12 inputs the generated prompt into the LLM 15. In this process, upon receiving input of a prompt that includes information on the target entity, an instruction to generate a fault-causal explanatory text related to the target entity, and the non-fault case document 102, the LLM 15 can output a fault-causal explanatory text for explaining the causal relation between the fault cause and the occurred fault. The LLM 15 will be described in detail below. The fault-causal explanatory text generation unit 12 obtains the fault-causal explanatory text output from the LLM 15 according to the input prompt.

To generate a fault-causal explanatory text in which the target entity is the fault cause, the fault-causal explanatory text generation unit 12 generates a prompt including the following information. For example, the prompt includes a query asking to "respond in writing explaining the mechanism of the occurrence of the fault, if there is a description from which the fault that occurs by the following fault cause can be estimated in the following document" or the like. Moreover, the prompt includes an example response such as "for example, give a response like the "event B occurs due to this fault cause, and as a result, the fault C occurs"". Moreover, the prompt includes information for specifying the "description of the non-fault case document" as a reference writing. Moreover, the prompt includes information for specifying the "description of the target entity" as the fault cause.

Moreover, to generate a fault-causal explanatory text in which the target entity is the fault, the fault-causal explanatory text generation unit 12 generates a prompt including the following information. For example, the prompt includes a query asking to "respond in writing explaining the mechanism of the occurrence of a fault, if there is a description from which the cause of the following fault can be estimated in the following document" or the like. Moreover, the prompt includes an example response such as "for example, give a response like the "event B occurs due to the event A, and as a result, this fault occurs"". Moreover, the prompt includes information for specifying the "description of the non-fault case document" as a reference writing. Moreover, the prompt includes information for specifying the "description of the target entity" as a fault.

In this process, the fault-causal explanatory text generation unit 12 may add a sentence for excluding the fault-causal explanatory text with a low reliability, to the prompt. For example, the fault-causal explanatory text generation unit 12 may add writing asking to "provide a response by giving a certainty factor to the response. Provide a response with a certainty factor using numerical values between 0 to 100. The certainty factor is increased with the increase in the numerical value" or the like, to the prompt. Then, if the certainty factor included in the response is equal to or less than a threshold, the fault-causal explanatory text generation unit 12 can recreate the fault-causal explanatory text using the LLM 15. In this case, the fault-causal explanatory text generation unit 12 may change the description of the prompt.

Then, if the certainty factor does not exceed the threshold even when the fault-causal explanatory text is recreated for a predetermined number of times, the fault-causal explanatory text generation unit 12 may skip the creation of a fault-causal explanatory text under that condition. Consequently, the fault-causal explanatory text generation unit 12 can improve the reliability of the fault-causal explanatory text, and improve the estimation accuracy of the final fault cause.

Moreover, if there are a plurality of the non-fault case documents 102 or when the amount of text is large, one document may be divided, and a fault-causal explanatory text may be generated for each of the divided documents. In such a case, when an explanatory text is generated for each of the divided documents, the contents may overlap. Therefore, the fault-causal explanatory text generation unit 12 may add a sentence for excluding the overlapped explanatory text from the fault-causal explanatory text, to the prompt. For example, to generate a fault-causal explanatory text in which the target entity is the fault cause, the fault-causal explanatory text generation unit 12 may add writing asking to "also include a keyword that briefly indicates the estimated fault in the response" or the like, to the prompt. Moreover, to generate a fault-causal explanatory text in which the target entity is the actual fault, the fault-causal explanatory text generation unit 12 may add writing asking to "also include a keyword that briefly indicates the estimated fault cause in the response" or the like, to the prompt.

Then, the fault-causal explanatory text generation unit 12 can adopt any one of the fault-causal explanatory texts in which the keywords in the response are overlapped. In this case, the fault-causal explanatory text generation unit 12 may limit the overlapping of keywords to a case where the keywords are the same, or may include a case where the keywords are similar. Consequently, the fault-causal explanatory text generation unit 12 can reduce the irrelevant fault-causal explanatory text, and can reduce the following process of the information processing device 1.

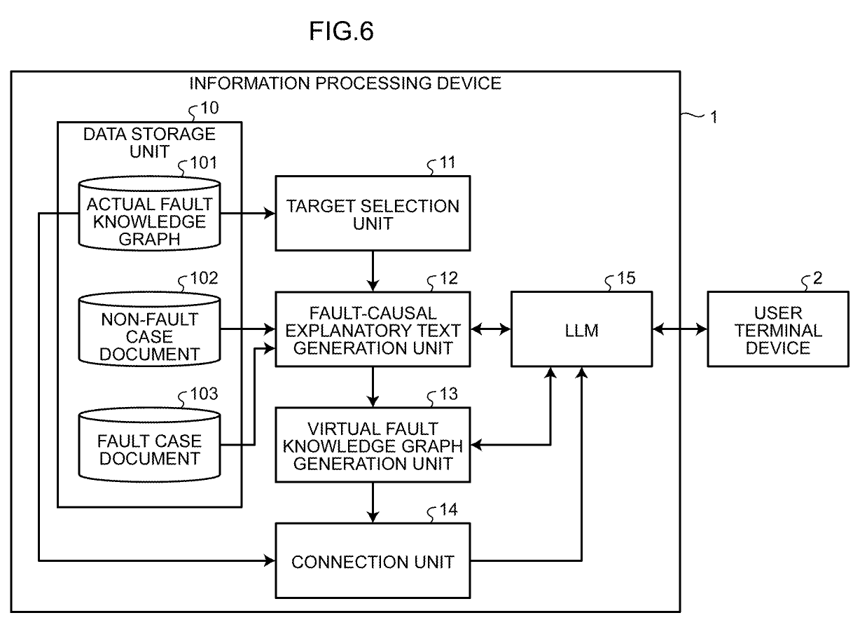

In addition, for example, to generate fault causality in which the target entity is the fault, the fault-causal explanatory text generation unit 12 may add a description on the target entity to the prompt, to improve the response performance of the LLM 15. FIG. 6 is a diagram for explaining an example of a prompt option. In this case, as illustrated in FIG. 6, the data storage unit 10 holds the fault case document 103.

The fault-causal explanatory text generation unit 12 extracts a description on the target entity such as a log from the fault case document 103, using the LLM 15. It is preferable to include the following information in the prompt for extracting a description on the target entity. For example, the prompt includes a query asking to "respond in a sentence that explains the following fault and an event observed in association with the following fault, for the following document" or the like. Moreover, the prompt includes an example response such as "for example, give a response like the "fault B has occurred. A message of Y is output to the log of X"". Moreover, the prompt includes the specification of conditions such as "refrain from including a description on the cause of this fault". Moreover, the prompt includes the specification of conditions such as "also, refrain from including a description on the fault other than this fault". However, the conditions are optional, and when a plurality of the occurred faults are included in the fault case document 103, or when the fault knowledge graph can include the occurred faults, the prompt is a directive that prevents a description on the occurred fault other than that of the target entity from being included. Moreover, the prompt includes information for specifying the "description of the fault case document" as a reference writing. Moreover, the prompt includes information for specifying the "description of the target entity" as an occurred fault.

Then, the fault-causal explanatory text generation unit 12 specifies the description extracted using this prompt, as a fault in the prompt for generating the fault-causal explanatory text. In this case, it is preferable to include the following information in the prompt for generating the fault-causal explanatory text. For example, the prompt includes a query asking to "respond in writing explaining the mechanism of the occurrence of a fault, if there is a description from which the cause of the following fault can be estimated in the following document" or the like. Moreover, the prompt includes an example response such as "for example, give a response like the "event B occurs due to the event A, and as a result, this fault occurs"". Moreover, the prompt includes information for specifying the "description of the non-fault case document" as a reference writing. Moreover, the prompt includes information for specifying the "description on the target entity" obtained from the prompt for extracting a description on the target entity, as a fault.

In this manner, the fault-causal explanatory text generation unit 12 generates a fault-causal explanatory text for explaining the events connected by a cause-result relation related to the first entity, from a second input document. Moreover, the fault-causal explanatory text generation unit 12 generates a fault-causal explanatory text using a large-scale language model. In detail, the fault-causal explanatory text generation unit 12 generates a prompt to provide a response with the fault-causal explanatory text related to the first entity on the basis of the second input document, and generates a fault-causal explanatory text by inputting the generated prompt to the large-scale language model.

In this case, the fault-causal explanatory text generation unit 12 may generate a prompt that makes the large-scale language model to provide a response with the certainty factor of the fault-causal explanatory text. Furthermore, the fault-causal explanatory text generation unit 12 may exclude the fault-causal explanatory text the certainty factor of which is equal to or less than a threshold. Moreover, the fault-causal explanatory text generation unit 12 may generate a prompt that makes the large-scale language model to provide a response with a keyword included in the fault-causal explanatory text. In this case, the fault-causal explanatory text generation unit 12 may select one of the fault-causal explanatory texts in which the keywords are overlapped.

Moreover, if the first entity is an event when a specific fault has occurred, the fault-causal explanatory text generation unit 12 can make the large-scale language model to generate a specific fault explanatory text for explaining the specific fault and an event observed for the specific fault, on the basis of the second input document. The description on the target entity used for enhancing the response performance of the LLM 15 corresponds to an example of the "specific fault explanatory text". Then, by using the specific fault and the specific fault explanatory text as an occurred fault, the fault-causal explanatory text generation unit 12 can generate a prompt to provide a response with the fault-causal explanatory text related to the occurred fault. Furthermore, the fault-causal explanatory text generation unit 12 can generate a specific fault explanatory text, by generating a specific fault explanatory text prompt that prevents a description of a fault other than that of the specific fault from being included in the specific fault explanatory text, and inputting the generated specific fault explanatory text prompt to the large-scale language model.

Returning to FIG. 1, the description will continue. The virtual fault knowledge graph generation unit 13 receives input of a fault-causal explanatory text on the basis of the target entity, from the fault-causal explanatory text generation unit 12. Then, the virtual fault knowledge graph generation unit 13 generates the virtual fault knowledge graph 200 indicating a causal relation between the virtual fault cause and the occurred fault, from the fault-causal explanatory text.

For example, the virtual fault knowledge graph generation unit 13 generates a prompt to generate the virtual fault knowledge graph 200 from the fault-causal explanatory text. Then, the virtual fault knowledge graph generation unit 13 inputs the generated prompt into the LLM 15. Upon receiving input of a prompt that instructs the LLM 15 to generate a fault-causal explanatory text and the virtual fault knowledge graph 200 on the basis of the fault-causal explanatory text, the LLM 15 generates the virtual fault knowledge graph 200 from the fault-causal explanatory text and outputs the generated virtual fault knowledge graph 200. The LLM 15 will be described in detail below. Subsequently, the virtual fault knowledge graph generation unit 13 obtains the virtual fault knowledge graph 200 illustrated in FIG. 4, that is output from the LLM 15 according to the input prompt. The virtual fault knowledge graph 200 illustrated in FIG. 4 is generated on the basis of the fault-causal explanatory text generated from the system operation management specification 140 that is the non-fault case document 102.

For example, the virtual fault knowledge graph generation unit 13 generates the virtual fault knowledge graph 200 that includes an event of QoS misconfiguration illustrated in FIG. 4 in an entity 201 serving as the fault-causing entity, and that includes an event of network delay in an entity 202 serving as the fault entity. The virtual fault knowledge graph 200 in FIG. 4 indicates a causal relation between the fault cause and the occurred fault indicated by a description 203 included in the system operation management specification 140.

Returning to FIG. 1, the description will continue. The virtual fault knowledge graph generation unit 13 generates a prompt including the following information. In this case, the prompt includes a query asking to "express the mechanism of the occurrence of a fault due to the fault cause using a graph, for the following document" or the like. Moreover, the prompt includes information for specifying the generation condition of a graph such as the "generated event is an entity, and an edge represents between the events in a causal relation". Moreover, the prompt includes an example response such as "for example, if the event B has occurred due to the event A, the edge is represented as (A, B)". Moreover, the prompt includes information for specifying the generation condition of a graph asking to "extract all edges" or the like. Moreover, the prompt includes information for specifying the "description of the fault case document" as a reference writing.

In this process, the virtual fault knowledge graph generation unit 13 may add a sentence that allows the virtual fault knowledge graph 200 to be properly connected to the actual fault knowledge graph 101 in the prompt. The virtual fault knowledge graph generation unit 13 can generate the virtual fault knowledge graph 200 that can be properly connected to the actual fault knowledge graph 101, by adding a sentence to include the entity having the same content as that of the target entity in the response. For example, the virtual fault knowledge graph generation unit 13 may add an instruction asking "to include the following entity without fail" or the like in the prompt, and add information for specifying the "target entity" as the entity in the prompt.

This non-fault case document 102 corresponds to the "second input document", the virtual fault knowledge graph 200 corresponds to an example of the "second knowledge graph", and the entity included in the virtual fault knowledge graph 200 corresponds to an example of a "second entity". The entity included in the virtual fault knowledge graph 200 indicates each of the events connected by a cause-result relation included in the non-fault case document 102 that is the second input document related to the fault case document 103 serving as the first entity. On the basis of the first entity and the second input document, the virtual fault knowledge graph generation unit 13 generates the second knowledge graph that includes the second entity indicating each of events connected by a cause-result relation included in the second input document, that is related to the first entity. More specifically, the virtual fault knowledge graph generation unit 13 generates the second knowledge graph on the basis of the fault-causal explanatory text generated by the fault-causal explanatory text generation unit 12.

Moreover, the virtual fault knowledge graph generation unit 13 may generate the second knowledge graph in which the first entity is an event when a specific fault has occurred, and that is connected by a cause-result relation from an event when the fault cause of the specific fault has occurred to an event when the specific fault has occurred. Moreover, the virtual fault knowledge graph generation unit 13 may generate the second knowledge graph in which the first entity is an event when the fault cause has occurred.

The connection unit 14 receives input of the virtual fault knowledge graph 200 from the virtual fault knowledge graph generation unit 13. Moreover, the connection unit 14 obtains the actual fault knowledge graph 101 including the target entity from the data storage unit 10. Then, the connection unit 14 connects the actual fault knowledge graph 101 including the target entity and the obtained virtual fault knowledge graph 200.

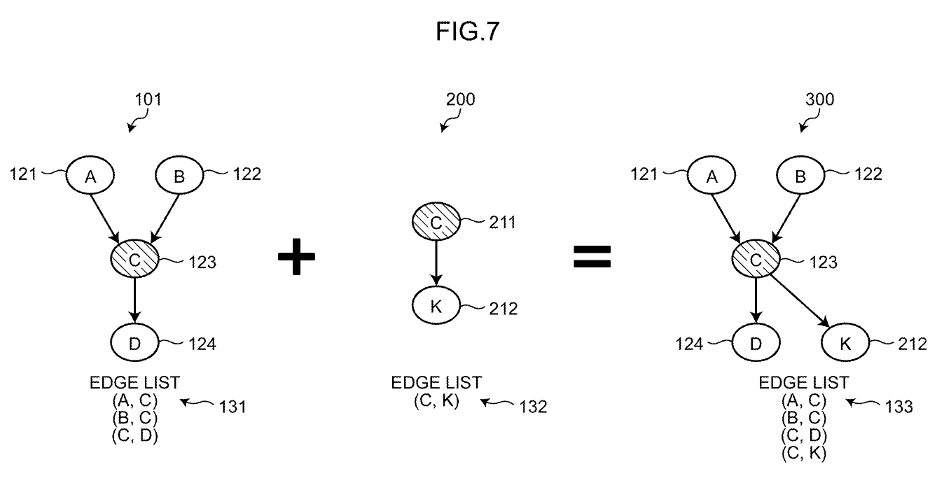

FIG. 7 is a diagram illustrating an example of a connection method between the actual fault knowledge graph and the virtual fault knowledge graph. For example, a case of connecting the actual fault knowledge graph 101 including entities 121 to 124, and the virtual fault knowledge graph 200 including entities 211 and 212 will be described.

In this case, the actual fault knowledge graph 101 is represented by an edge list 131. Moreover, in this case, the virtual fault knowledge graph 200 is represented by an edge list 132.

For example, the connection unit 14 can simply connect the actual fault knowledge graph 101 and the virtual fault knowledge graph 200, by simply generating an edge list 133 in which the edge representations in the edge list 131 and the edge representations in the edge list 132 are arranged side by side after eliminating the overlaps. In this case, the entity 123 in the actual fault knowledge graph 101 and the entity 211 in the virtual fault knowledge graph 200 both represent the same event C. Hence, the actual fault knowledge graph 101 and the virtual fault knowledge graph 200 are connected. That is, the connection unit 14 has connected the entity 123 in the actual fault knowledge graph 101 and the entity 211 in the virtual fault knowledge graph 200. Consequently, the connection unit 14 generates the connected knowledge graph 300 including the entities 121 to 124 and the entity 212 indicating an event K linked from the entity 123 by an edge.

In this manner, the connection unit 14 generates a new connected knowledge graph 300 by connecting the actual fault knowledge graph 101 and the virtual fault knowledge graph 200. Subsequently, the connection unit 14 outputs the generated connected knowledge graph 300 to the LLM 15.

This connected knowledge graph 300 corresponds to an example of a "third knowledge graph". That is, the connection unit 14 generates the third knowledge graph by connecting the first knowledge graph and the second knowledge graph.

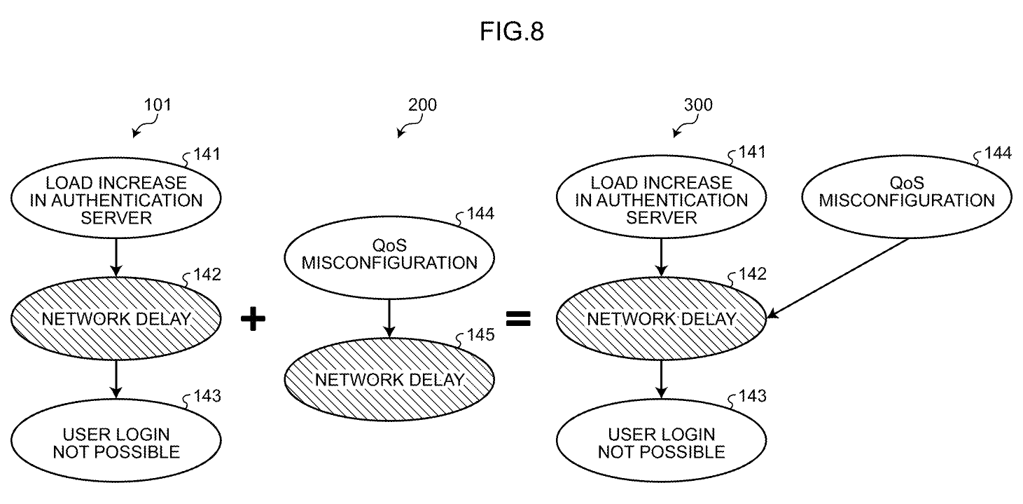

FIG. 8 is a diagram illustrating a specific image of connecting the actual fault knowledge graph and the virtual fault knowledge graph. For example, the actual fault knowledge graph 101 includes an entity 141 indicating an event of "load increase in the authentication server", an entity 142 indicating an event of "network delay", and an entity 143 indicating an event of "user login not possible". These entities have a causal relation in which the event of "network delay" is caused by the event of "load increase in the authentication server", and the event of "load increase in the authentication server" is caused by the event of "network delay".

Moreover, the virtual fault knowledge graph 200 includes an entity 144 indicating an event of "QoS misconfiguration" and an entity 145 indicating an event of "network delay". These entities have a causal relation in which the event of "network delay" is caused by the event of "QoS misconfiguration".

Because the entity 142 in the actual fault knowledge graph 101 and the entity 145 in the virtual fault knowledge graph 200 indicate the same event, the connection unit 14 connects the entity 142 and the entity 145. Consequently, the connection unit 14 generates the connected knowledge graph 300 including the entities 141 to 144. This connected knowledge graph 300 is a knowledge graph obtained by adding the causal relation in which the event of "network delay" is caused by the event of "QoS misconfiguration", to the original actual fault knowledge graph 101.

In this process, a plurality of connected patterns will be described. In the example, an entity serving as a connection point in the virtual fault knowledge graph 200 is referred to as the entity of the connection destination. The connected pattern is determined depending on the types of the entity of the connection origin and the entity of the connection destination.

The entity of the connection origin is the target entity selected by the target selection unit 11, and three types of the fault-causing entity, the intermediate event entity, and the fault entity are to be taken into consideration. The entity of the connection destination is an entity indicating the same event as that of the target entity in the virtual fault knowledge graph 200, and two types of the fault-causing entity and the fault entity are to be taken into consideration. The connected pattern includes a pattern in which the connection origin and the connection destination are both fault entities, and a pattern in which the connection origin and the connection destination are both fault-causing entities. Furthermore, the connected pattern includes a pattern in which the entity of the connection origin is the intermediate event entity, and the entity of the connection destination is the fault-causing entity or the fault entity.

In this process, the connection when the entity of the connection destination is the intermediate event entity, is included in the connection when the entity of the connection destination is either the fault-causing entity or the fault entity. Therefore, in the example, the connection when the entity of the connection destination is the intermediate event entity, is excluded from the connected pattern. However, the connection unit 14 may perform connection using the entity of the connection destination as the intermediate event entity.

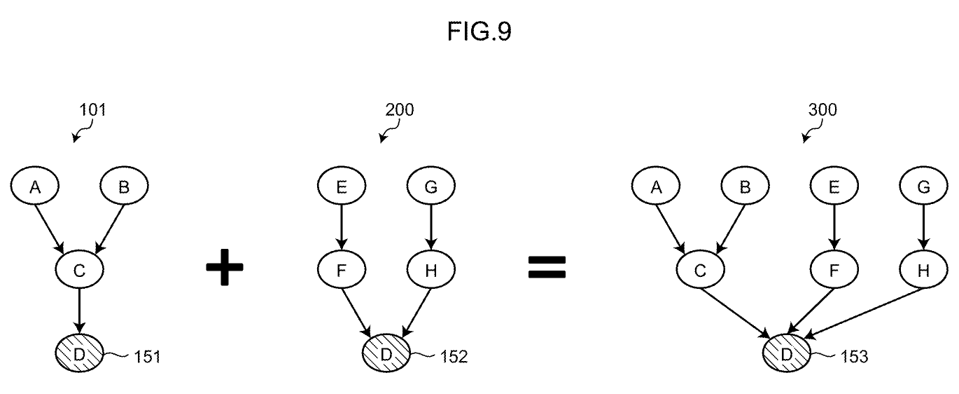

FIG. 9 is a diagram illustrating a connected pattern when the connection origin and the connection destination are both fault entities. In this case, an entity 151 in the actual fault knowledge graph 101 is the fault entity and the entity of the connection origin. Moreover, an entity 152 in the virtual fault knowledge graph 200 is the fault entity and the entity of the connection destination. The connection unit 14 generates the connected knowledge graph 300, by connecting the actual fault knowledge graph 101 and the virtual fault knowledge graph 200 using the entity 151 and the entity 152 as the connection point. An entity 153 in the connected knowledge graph 300 is the connection point. In the connected pattern, compared to the original actual fault knowledge graph 101, the number of paths leading to the fault entity from the other fault-causing entity is increased.

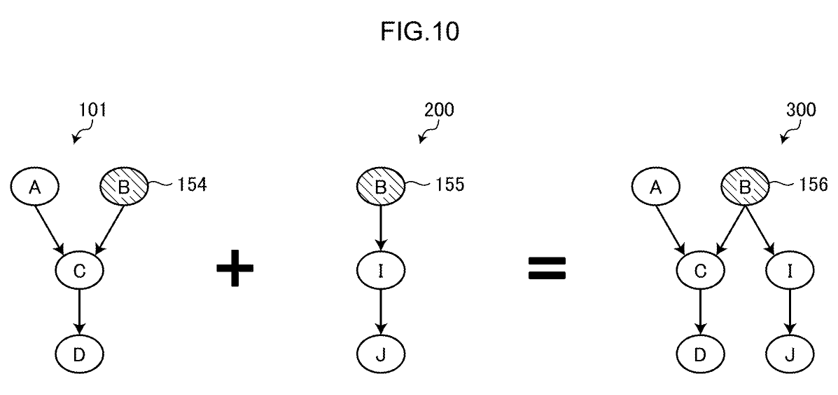

FIG. 10 is a diagram illustrating a connected pattern when the connection origin and the connection destination are both fault-causing entities. In this case, an entity 154 in the actual fault knowledge graph 101 is the fault-causing entity and the entity of the connection origin. Moreover, an entity 155 in the virtual fault knowledge graph 200 is the fault-causing entity and the entity of the connection destination. The connection unit 14 generates the connected knowledge graph 300, by connecting the actual fault knowledge graph 101 and the virtual fault knowledge graph 200 using the entity 154 and the entity 155 as the connection point. An entity 156 in the connected knowledge graph 300 is the connection point. In this connected pattern, compared to the original actual fault knowledge graph 101, the number of paths extending to the other fault entity from the fault-causing entity is increased.

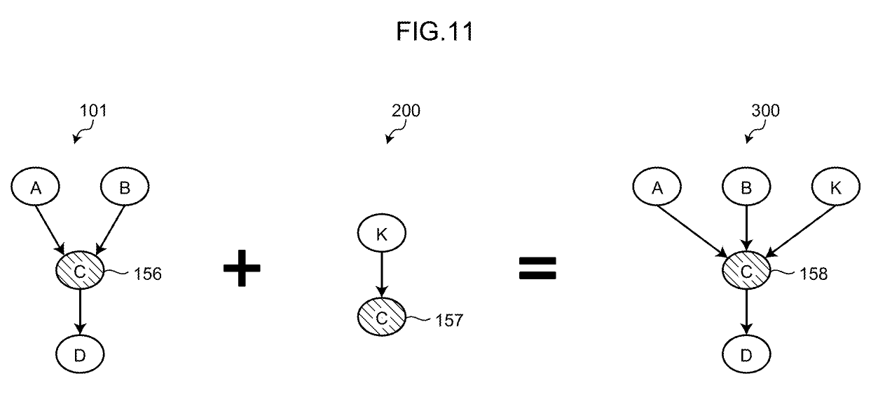

FIG. 11 is a diagram illustrating a connected pattern when the entity of the connection origin is the intermediate event entity, and the entity of the connection destination is the fault-causing entity or the fault entity. In this case, an entity 156 in the actual fault knowledge graph 101 is the intermediate event entity and the entity of the connection origin. Moreover, an entity 157 in the virtual fault knowledge graph 200 is the fault entity and the entity of the connection destination. The connection unit 14 generates the connected knowledge graph 300, by connecting the actual fault knowledge graph 101 and the virtual fault knowledge graph 200 using the entity 156 and the entity 157 as the connection point. An entity 158 in the connected knowledge graph 300 is the connection point. In this connected pattern, compared to the original actual fault knowledge graph 101, the number of paths leading to the intermediate event entity from the other fault-causing entity, or the number of paths extending to the other fault entity from the intermediate event entity is increased.

In this process, the connected knowledge graph 300 is generated for the target entities sequentially selected by the target selection unit 11. For example, for one entity included in one actual fault knowledge graph 101, it is assumed that one connected knowledge graph 300 is generated using one non-fault case document 102. In such a case, it is assumed that all entities in the actual fault knowledge graph 101 are used, and the connected knowledge graphs 300 as many as the total number of entities included in each actual fault knowledge graph 101 are generated. Moreover, the number of the connected knowledge graphs 300 to be generated also increases according to the number of the non-fault case documents 102 to be used. A plurality of new fault knowledge graphs generated in this manner are sent to the LLM 15.

Moreover, in the above description, one virtual fault knowledge graph 200 is generated from one non-fault case document 102. However, a plurality of the virtual fault knowledge graphs 200 may be generated from one non-fault case document 102. Then, the virtual fault knowledge graphs 200 may be connected to one actual fault knowledge graph 101. In such a case, the connection unit 14 can generate one connected knowledge graph 300, by sequentially and simply connecting the virtual fault knowledge graphs 200 that can be connected to the actual fault knowledge graph 101, to the actual fault knowledge graph 101.

Returning to FIG. 1, the description will continue. The LLM 15 is a large-scale machine learning model that performs natural language processing. For example, upon receiving input of a prompt that includes information on the entity, an instruction to generate a fault-causal explanatory text related to the entity, and the non-fault case document 102 serving as the information extraction source, the LLM 15 outputs the fault-causal explanatory text for explaining a causal relation between the fault cause and the occurred fault.

Moreover, upon receiving input of a prompt that instructs the LLM 15 to generate a fault-causal explanatory text and the virtual fault knowledge graph 200 on the basis of the fault-causal explanatory text, the LLM 15 generates the virtual fault knowledge graph 200 from the fault-causal explanatory text and outputs the generated virtual fault knowledge graph 200.

Moreover, upon receiving input of the occurred fault sent from the user terminal device 2, the LLM 15 estimates the fault cause of the specified occurred fault, using the connected knowledge graph 300. Subsequently, the LLM 15 transmits the fault cause of the specified occurred fault that is the estimated result to the user terminal device 2, and provides the user with the fault cause.

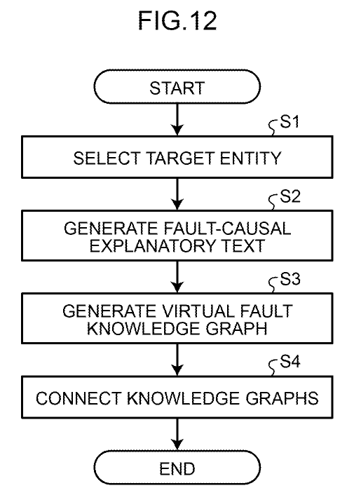

FIG. 12 is a flowchart of a generation process of a connected knowledge graph by the information processing device according to the first embodiment. Next, with reference to FIG. 12, a flow of the generation process of the connected knowledge graph by the information processing device 1 according to the first embodiment will be described.

The target selection unit 11 selects the target entity serving as the reference for generating the connected knowledge graph 300, from the actual fault knowledge graph 101 (step S1).

Depending on whether the target entity is the fault cause or whether the target entity is the occurred fault, the fault-causal explanatory text generation unit 12 generates a prompt to generate a fault-causal explanatory text related to the target entity on the basis of the non-fault case document 102. Then, by inputting the generated prompt to the LLM 15 and obtaining the output, the fault-causal explanatory text generation unit 12 generates a fault-causal explanatory text (step S2).

The virtual fault knowledge graph generation unit 13 generates a prompt to generate the virtual fault knowledge graph 200 from the fault-causal explanatory text. Then, by inputting the generated prompt to the LLM 15 and obtaining the output, the virtual fault knowledge graph generation unit 13 generates the virtual fault knowledge graph 200 (step S3).

The connection unit 14 generates the connected knowledge graph 300, by simply connecting the actual fault knowledge graph 101 and the virtual fault knowledge graph 200 (step S4).

As described above, the information processing device 1 according to the present embodiment generates the virtual fault knowledge graph 200 from the non-fault case document 102, for the fault indicated in the actual fault knowledge graph 101 on the basis of the fault case document 103. Then, the information processing device 1 generates the connected knowledge graph 300, by connecting the actual fault knowledge graph 101 and the generated virtual fault knowledge graph 200.

By estimating the fault cause of the fault specified by a user, using the connected knowledge graph 300 generated in this manner, it is possible to estimate the fault cause while taking into account the content of the non-fault case document 102 in addition to that of the fault case document 103. Hence, it is possible to improve the response performance with respect to the query.

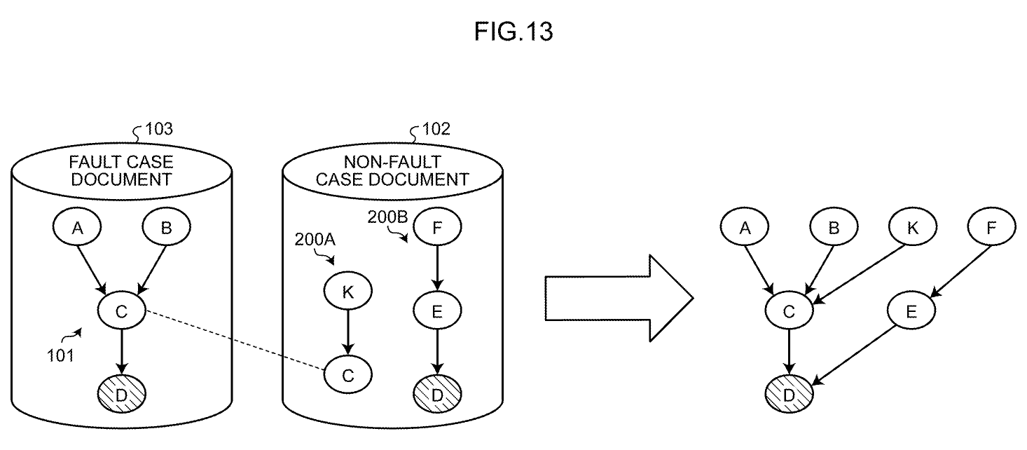

FIG. 13 is a diagram for explaining the effects of generating the connected knowledge graph. In the example, two virtual fault knowledge graphs 200A and 200B are generated from the non-fault case document 102.

The information processing device 1 according to the present embodiment generates the two virtual fault knowledge graphs 200A and 200B from the non-fault case document 102. Then, the information processing device 1 generates the connected knowledge graph 300, by connecting the fault case document 103 and the two virtual fault knowledge graphs 200A and 200B. Then, by using the connected knowledge graph 300, the information processing device 1 estimates the fault cause of the fault specified by a user. Consequently, the information processing device 1 can give a response by estimating the fault cause on the basis of the fault causality that is unable to identify from either the fault case document 103 or non-fault case document 102 alone. Hence, it is possible to improve the response performance.

For example, in the response based on the fault case document 103 alone, events A, B, and F are presented as the cause of the event D serving as the occurred fault. Moreover, in the response based on the non-fault case document 102 alone, it is possible to present an event K as the cause of the event C. However, the relation with the event D serving as the occurred fault is unknown.

In contrast, when asked what is the fault cause of a fault, which is the event D, the information processing device 1 according to the present embodiment estimates the fault cause, by following the connected knowledge graph 300 from the entity of the event D toward the fault cause. In this case, the information processing device 1 can provide a response that the fault cause of the fault, which is the event D, is the events A, B, K, or F. That is, the information processing device 1 can present the event F that is not presented in the response based on the fault case document 103 alone, and can give a more appropriate response to the query. Hence, it is possible to improve the response performance.

### (b) Second Embodiment

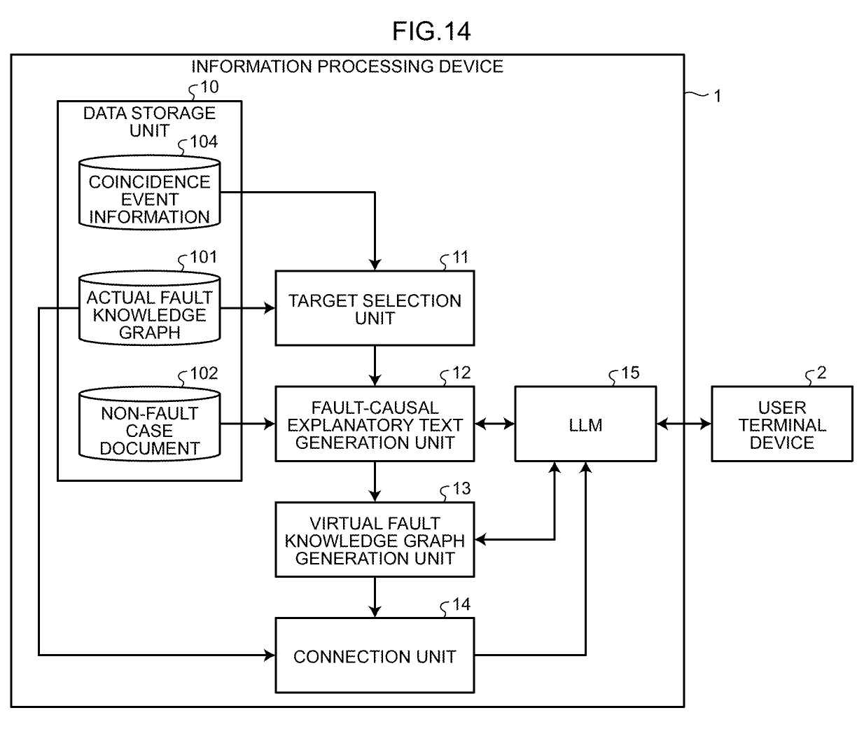

FIG. 14 is a block diagram of an information processing device according to a second embodiment. The information processing device 1 according to the present embodiment differs from that in the first embodiment, in generating the connected knowledge graph 300 by collectively taking into account a plurality of events that become a fault when the events occur at the same time. In the following description, the operation of each unit according to the first embodiment may be omitted.

The data storage unit 10 according to the present embodiment holds coincidence event information 104. Coincidence events are a plurality of events that become a fault when the events occur at the same time.

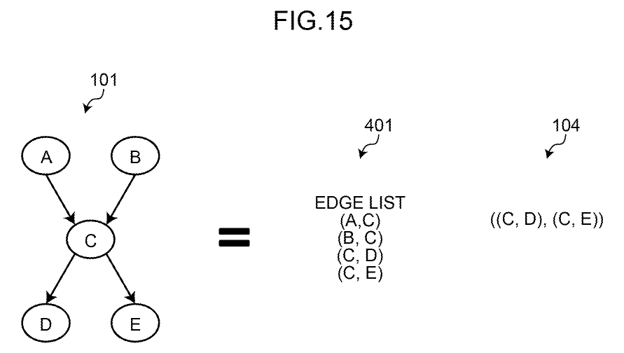

FIG. 15 is a diagram illustrating an example of information held by the information processing device according to the second embodiment. For example, the data storage unit 10 holds the coincidence event information 104 illustrated in FIG. 15, in addition to an edge list 401 indicating the actual fault knowledge graph 101 illustrated in FIG. 15.

In the actual fault knowledge graph 101 in FIG. 15, the events A and B are present as the fault cause, the event C is present as the intermediate event, and the events D and E are present as the occurred faults. However, in this case, a fault does not occur unless the event D and the event E occur at the same time. That is, a fault does not occur when the event D occurs alone, or when the event E occurs alone.

Therefore, in the present embodiment, the data storage unit 10 holds the coincidence event information 104 of ((C, D), (C, E)) representing that a fault occurs when the event D and the event E occur at the same time. That is, the content of the actual fault knowledge graph 101 including coincidence events is accurately represented by a set of the edge list 401 and the coincidence event information 104. That is, a plurality of entities that are coincidence events are treated as an entity group, by the coincidence event information 104.

A set of several entities indicating an event in which a specific event occurs when the events occur at the same time, indicated by the coincidence event information 104, corresponds to an example of a "first entity group". That is, the actual fault knowledge graph 101 that is the first knowledge graph includes a set of several first entities in which a specific event occurs when the events indicated by the first entities occur at the same time, as one first entity group.

The target selection unit 11 selects a target entity from the actual fault knowledge graph 101. However, for the entities serving as the coincidence events in the coincidence event information 104, the target selection unit 11 collectively selects the entities as one entity group. That is, the target selection unit 11 can select one first entity group included in the first knowledge graph, from the first knowledge graph that includes a set of the first entities in which a specific event occurs when the events indicated by the first entities occur at the same time, as one first entity group.

The fault-causal explanatory text generation unit 12 generates a prompt to generate a fault-causal explanatory text related to the target entity on the basis of the non-fault case document 102, using the content obtained by connecting the entities of the entity group with "and", as one target entity. Then, the fault-causal explanatory text generation unit 12 generates a fault-causal explanatory text from the non-fault case document 102 using the LLM 15. The fault-causal explanatory text generation unit 12 can generate a fault-causal explanatory text for the fault that occurs when the events of the entity group occur at the same time.

In this case, the fault-causal explanatory text generation unit 12 can generate a prompt for generating a naturally expressed sentence. In this case, it is preferable that the fault-causal explanatory text generation unit 12 generates a prompt including the following information. For example, the prompt includes a query asking to "respond in writing saying that a plurality of faults indicated in the following fault list have occurred at the same time, for the following fault case document" or the like. Moreover, the prompt includes information for specifying the "description of the fault case document" as a reference writing. Moreover, the prompt includes information for specifying the description of the entity group as a fault.

The virtual fault knowledge graph generation unit 13 creates a prompt for generating the virtual fault knowledge graph 200 from the fault-causal explanatory text. In this prompt, the entity group is treated as one entity. Then, by inputting the generated prompt to the LLM 15 and obtaining the output, the virtual fault knowledge graph generation unit 13 generates the virtual fault knowledge graph 200. In the virtual fault knowledge graph 200 created at this stage, the entity group is represented as one entity.

Next, if the target entity is the entity group, the virtual fault knowledge graph generation unit 13 updates the virtual fault knowledge graph 200, by decomposing the entity indicating the entity group, and replacing the decomposed entities with the original entity. Consequently, the virtual fault knowledge graph generation unit 13 matches the representation of the entities corresponding to the entity group in the virtual fault knowledge graph 200 with the representation of the entities corresponding to the entity group in the actual fault knowledge graph 101. The actual fault knowledge graph 101 and the virtual fault knowledge graph 200 are in a connectable state. Furthermore, the virtual fault knowledge graph generation unit 13 generates the coincidence event information 104 indicating that the entities serving as an entity group are coincidence events.

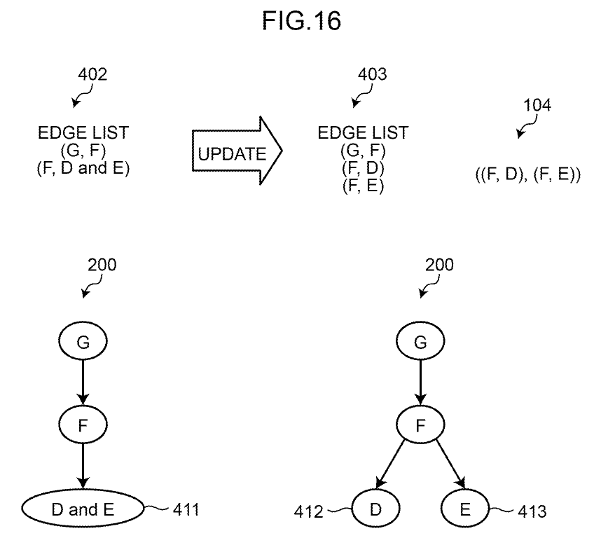

FIG. 16 is a diagram illustrating the generation of a virtual fault knowledge graph by the information processing device according to the second embodiment. In the example, the event D and the event E are coincidence events. The virtual fault knowledge graph generation unit 13 generates the virtual fault knowledge graph 200 including an entity 411 from the fault-causal explanatory text. The entity 411 is an entity group indicating that the event D and the event E are connected with "and", and the event D and the event E are coincidence events. In practice, the virtual fault knowledge graph generation unit 13 generates an edge list 402 representing the virtual fault knowledge graph 200.

Next, the virtual fault knowledge graph generation unit 13 updates the virtual fault knowledge graph 200, by removing "and" in the entity group indicated by the entity 411, and decomposing the entity group into an entity 412 indicating the event D and an entity 413 indicating the event E. In practice, the virtual fault knowledge graph generation unit 13 creates an edge list 403, by dividing (F, D, and E) that is the edge representation of the entity group in the edge list 402, into two edge representations of (F, D) and (F, E). Furthermore, the virtual fault knowledge graph generation unit 13 generates the coincidence event information 104 of ((F,D), (F,E)) indicating that the event D and the event E are coincidence events, and adds the generated coincidence event information 104 to the virtual fault knowledge graph 200.

In this manner, the virtual fault knowledge graph generation unit 13 generates the virtual fault knowledge graph 200, by using a set of the second entities indicating an event the same as that of each of the several first entities included in the first entity group, as one second entity group. For example, a set of the events D and E connected with "and" in FIG. 16 corresponds to an example of the "second entity group".

The connection unit 14 generates the connected knowledge graph 300, by simply connecting the actual fault knowledge graph 101 and the virtual fault knowledge graph 200. In this case, the connection unit 14 makes the coincidence event information 104 for the connected knowledge graph 300, by combining the coincidence event information 104 added to the actual fault knowledge graph 101 and the coincidence event information 104 added to the virtual fault knowledge graph 200.

As described above, even when there are events that become a fault when the events occur at the same time, the information processing device 1 according to the present embodiment can generate the connected knowledge graph 300 while considering the case when the events occur at the same time, as a fault. Thus, it is possible to generate the connected knowledge graph 300 that can further adapt to the actual fault, and by estimating the fault cause using such a connected knowledge graph 300, it is possible to improve the response performance.

### c Third Embodiment

Next, a third embodiment will be described. The information processing device 1 according to the present embodiment generates one connected knowledge graph 300, from a plurality of the actual fault knowledge graphs 101 and a plurality of the non-fault case documents 102. In the following description, the operation of each unit similar to that in the first embodiment will be omitted.

The connection unit 14 according to the present embodiment generates one connected knowledge graph 300, by connecting one actual fault knowledge graph 101 and the virtual fault knowledge graph 200 based on the one non-fault case document 102. The connection unit 14 generates the connected knowledge graph 300 one by one, for each combination of the actual fault knowledge graphs 101 and the non-fault case documents 102. Then, the connection unit 14 generates the one connected knowledge graph 300, by further connecting the generated connected knowledge graphs 300.

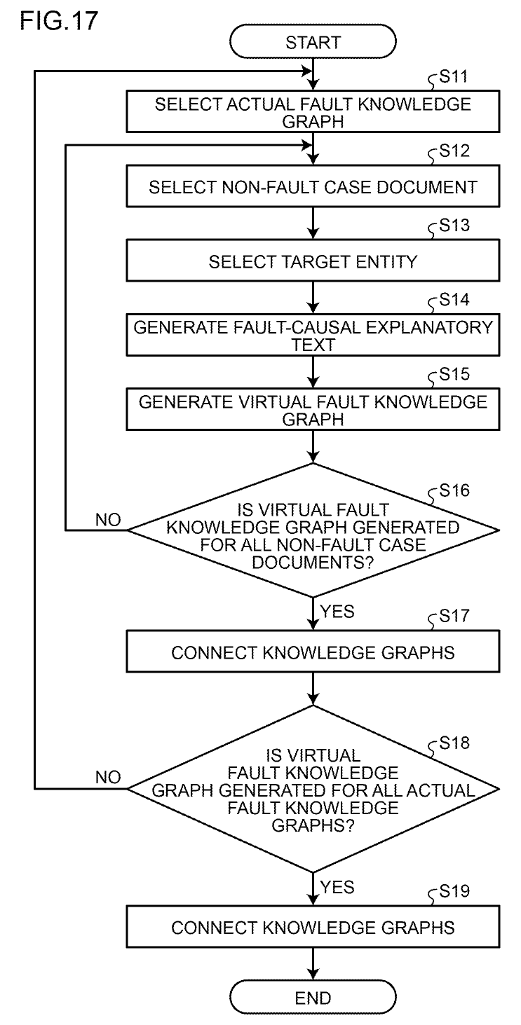

FIG. 17 is a flowchart of a generation process of a connected knowledge graph by an information processing device according to a third embodiment. Next, with reference to FIG. 17, a flow of the generation method of a connected knowledge graph by the information processing device 1 according to the present embodiment will be described.

The target selection unit 11 selects one actual fault knowledge graph 101 from the actual fault knowledge graphs 101 (step S11).

Moreover, the fault-causal explanatory text generation unit 12 selects one non-fault case document 102 from the non-fault case documents 102 (step S12).

Next, the target selection unit 11 selects the target entity serving as the reference for generating the connected knowledge graph 300, from the selected actual fault knowledge graph 101 (step S13).

Next, depending on whether the target entity is the fault cause or the target entity is the occurred fault, the fault-causal explanatory text generation unit 12 generates a prompt to generate a fault-causal explanatory text related to the target entity on the basis of the selected non-fault case document 102. Then, by inputting the generated prompt to the LLM 15 and obtaining the output, the fault-causal explanatory text generation unit 12 generates a fault-causal explanatory text (step S14).

The virtual fault knowledge graph generation unit 13 generates a prompt to generate the virtual fault knowledge graph 200 from the fault-causal explanatory text. Then, by inputting the generated prompt to the LLM 15 and obtaining the output, the virtual fault knowledge graph generation unit 13 generates the virtual fault knowledge graph 200 (step S15).

Next, the fault-causal explanatory text generation unit 12 determines whether the virtual fault knowledge graph 200 is generated for all the non-fault case documents 102 (step S16). If the virtual fault knowledge graph 200 is not yet generated for all the non-fault case documents 102 (No at step S16), the generation process of the connected knowledge graph returns to step S12.

In contrast, if the virtual fault knowledge graph 200 is generated for all the non-fault case documents 102 (Yes at step S16), the connection unit 14 simply connects the actual fault knowledge graph 101 and all the generated virtual fault knowledge graphs 200. Consequently, the connection unit 14 generates one connected knowledge graph 300 (step S17).

Next, the target selection unit 11 determines whether the virtual fault knowledge graph 200 is generated for all the actual fault knowledge graphs 101 (step S18). If the virtual fault knowledge graph 200 is not yet generated for all the actual fault knowledge graphs 101 (No at step S18), the generation process of the connected knowledge graph returns to step S11.

In contrast, if the virtual fault knowledge graph 200 is generated for all the actual fault knowledge graphs 101 (Yes at step S18), the connection unit 14 connects all the generated connected knowledge graphs 300. Consequently, the connection unit 14 generates one connected knowledge graph 300 (step S19).

As described above, the information processing device 1 according to the present embodiment generates one connected knowledge graph 300, by connecting the actual fault knowledge graphs 101 and the virtual fault knowledge graphs 200 based on the non-fault case documents 102. That is, the generated connected knowledge graph 300 includes the causal relation between the occurred fault and the fault cause, obtained from a plurality of the fault case documents 103 and the non-fault case documents 102. Thus, by estimating the fault cause of the fault specified by a user, using the connected knowledge graph 300, it is possible to estimate the fault cause on the basis of the contents of the fault case documents 103 and the non-fault case documents 102. Hence, it is possible to improve the estimation accuracy of the fault cause.

That is, if there are a plurality of the actual fault knowledge graphs 101, one of the actual fault knowledge graphs 101 corresponds to an example of the first knowledge graph. Then, another one corresponds to an example of a "fourth knowledge graph that includes a plurality of third entities indicating events connected by a cause-result relation on the basis of the third input document". That is, the target selection unit 11 selects the third entity from the fourth knowledge graph that includes the third entities indicating events connected by a cause-result relation on the basis of the third input document. On the basis of the third entity and the second input document, the virtual fault knowledge graph generation unit 13 generates a fifth knowledge graph that includes a fourth entity indicating each of events connected by a cause-result relation included in the second input document, that is related to the third entity. The connection unit 14 generates one connected knowledge graph 300, by further connecting the connected knowledge graph 300 obtained by connecting the fourth knowledge graph and the fifth knowledge graph, and the third knowledge graph generated on the basis of the first knowledge graph and the second input document. That is, the connection unit 14 generates a sixth knowledge graph, by connecting the third knowledge graph generated on the basis of the first knowledge graph and the second input document, and the fourth knowledge graph and the fifth knowledge graph that are generated anew.

Moreover, if there are a plurality of the non-fault case documents 102, one of the non-fault case documents 102 corresponds to an example of the second input document, and another one corresponds to an example of the "third input document". Then, on the basis of the first entity and the third input document, the virtual fault knowledge graph generation unit 13 generates the fourth knowledge graph that includes the third entity indicating each of events connected by a cause-result relation included in the third input document, that is related to the first entity. That is, in this case, the third knowledge graph and the fourth knowledge graph are generated for the first knowledge graph. The connection unit 14 generates the fifth knowledge graph, by connecting the first knowledge graph, the third knowledge graph, and the fourth knowledge graph.

### Hardware Configuration

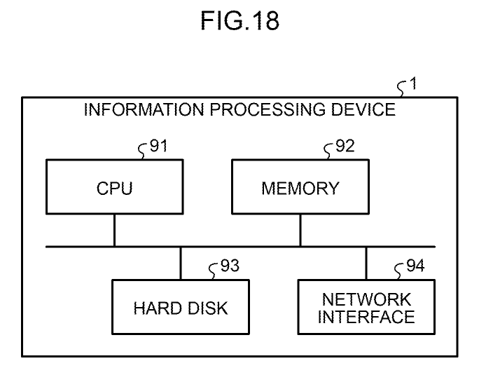

FIG. 18 is a hardware configuration diagram of the information processing device. Next, with reference to FIG. 18, an example of a hardware configuration for implementing each function of the information processing device 1 will be described.

As illustrated in FIG. 18, for example, the information processing device 1 includes a central processing unit (CPU) 91, a memory 92, a hard disk 93, and a network interface 94. The CPU 91 is connected to the memory 92, the hard disk 93, and the network interface 94 via a bus.

The network interface 94 is an interface for communication between the information processing device 1 and an external device. For example, the network interface 94 relays communication between the user terminal device 2 and the CPU 91.

The hard disk 93 is an auxiliary storage device. The hard disk 93 implements the function of the data storage unit 10 illustrated in FIG. 1. Moreover, the hard disk 93 may store the LLM 15. Moreover, the hard disk 93 stores various computer programs, including computer programs that implement the functions of the target selection unit 11, the fault-causal explanatory text generation unit 12, the virtual fault knowledge graph generation unit 13, and the connection unit 14 illustrated in FIG. 1.

The memory 92 is a main storage device. For example, a dynamic random access memory (DRAM) may be used for the memory 92.

The CPU 91 reads various computer programs from the hard disk 93, develops the read computer programs in the memory 92, and executes the developed computer programs. Consequently, the CPU 91 implements the functions of the target selection unit 11, the fault-causal explanatory text generation unit 12, the virtual fault knowledge graph generation unit 13, and the connection unit 14, as illustrated in FIG. 1.

In one aspect, the present invention can improve the response performance with respect to the query.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A generation method comprising:
selecting a first entity from a first knowledge graph that includes a plurality of the first entities indicating events connected by a cause-result relation based on a first input document;
generating a second knowledge graph that includes a second entity indicating each of events connected by a cause-result relation included in a second input document, that is related to the first entity, based on the selected first entity and the second input document; and
generating a third knowledge graph by connecting the first knowledge graph and the second knowledge graph by a processor.

2. The generation method according to claim 1, wherein the process of selecting the first entity includes a process of selecting one entity included in the first knowledge graph.

3. The generation method according to claim 1, wherein
the first input document is a document that describes a fault content of an actual fault and a fault cause, and
the second input document is a document that includes a description on the actual fault described in the first input document.

4. The generation method according to claim 3, wherein the process of selecting the first entity includes a process of selecting one or a combination of a fault entity indicating an event when the actual fault has occurred, a fault-causing entity indicating an event to be the fault cause, and an intermediate event entity indicating an event that occurs between the actual fault and the fault cause included in the first knowledge graph, from the first entities including the fault entity, the fault-causing entity, and the intermediate event entity.

5. The generation method according to claim 1, wherein the generation process of the second knowledge graph includes a process of generating the second knowledge graph in which the first entity is an event when a specific fault has occurred, and that is connected by a cause-result relation from an event when a fault cause of the specific fault has occurred to an event when the specific fault has occurred.

6. The generation method according to claim 1, wherein the generation process of the second knowledge graph includes a process of generating the second knowledge graph in which the first entity is an event when a fault cause of a specific fault has occurred, and that is connected by a cause-result relation from an event when the fault cause of the specific fault has occurred to an event when the specific fault has occurred.

7. The generation method according to claim 1, wherein
the process of generating the second knowledge graph includes a process of
generating a fault-causal explanatory text for explaining an event connected by a cause-result relation related to the first entity from the second input document, and
generating the second knowledge graph based on the fault-causal explanatory text.

8. The generation method according to claim 7, wherein the process of generating the fault-causal explanatory text includes a process of generating the fault-causal explanatory text using a large-scale language model.

9. The generation method according to claim 8, wherein
the process of generating the fault-causal explanatory text includes a process of
generating a prompt to provide a response with the fault-causal explanatory text related to the first entity based on the second input document, and
generating the fault-causal explanatory text by inputting the prompt to the large-scale language model.

10. The generation method according to claim 9, wherein the generation process of the prompt includes a prompt that makes the large-scale language model to provide a response with a certainty factor of the fault-causal explanatory text.

11. The generation method according to claim 10, wherein the generation process of the fault-causal explanatory text includes a process of excluding the fault-causal explanatory text the certainty factor of which is equal to or less than a threshold.

12. The generation method according to claim 9, wherein the generation process of the prompt includes a prompt that makes the large-scale language model to provide a response with a keyword included in the fault-causal explanatory text.

13. The generation method according to claim 12, wherein the generation process of the fault-causal explanatory text includes a process of selecting one of a plurality of the fault-causal explanatory texts in which the keywords are overlapped.

14. The generation method according to claim 9, wherein
the generation process of the prompt includes a process of
when the first entity is an event when a specific fault has occurred, causing the large-scale language model to generate a specific fault explanatory text for explaining the specific fault and an event observed for the specific fault, based on the second input document, and
by using the specific fault and the specific fault explanatory text as an occurred fault, generating a prompt to provide a response with the fault-causal explanatory text related to the occurred fault.

15. The generation method according to claim 14, wherein
the generation process of the prompt includes a process of
generating a specific fault explanatory text prompt that prevents a description of a fault other than that of the specific fault from being included in the specific fault explanatory text, and
generating the specific fault explanatory text by inputting the specific fault explanatory text prompt to the large-scale language model.

16. The generation method according to claim 1, wherein
the process of selecting the first entity includes a process of selecting one first entity group, from the first knowledge graph that includes a set of the first entities in which a specific event occurs when events indicated by the first entities occur at a same time, as one first entity group,
the first knowledge graph includes a set of the first entities in which a specific event occurs when events indicated by the first entities occur at a same time, as one first entity group, and
the process of generating the second knowledge graph includes a process of generating the second knowledge graph using a set of the second entities indicating an event same as that of each of the set of the first entities included in the first entity group, as one second entity group.

17. The generation method according to claim 1, wherein
the information processing device further executes a process of
selecting a third entity from a fourth knowledge graph that includes a plurality of the third entities indicating events connected by a cause-result relation based on a third input document,
generating a fifth knowledge graph that includes a fourth entity indicating each of events connected by a cause-result relation included in the second input document, that is related to the third entity, based on the selected third entity and the second input document, and
generating a sixth knowledge graph by connecting the third knowledge graph, the fourth knowledge graph, and the fifth knowledge graph.

18. The generation method according to claim 1, wherein
the information processing device further executes a process of
generating a fourth knowledge graph that includes a third entity indicating each of events connected by a cause-result relation included in a third input document, that is related to the first entity, based on the selected first entity and the third input document, and
generating a fifth knowledge graph by connecting the first knowledge graph, the third knowledge graph, and the fourth knowledge graph.

19. A non-transitory computer-readable recording medium having stored therein a generation program that causes a computer to execute a process comprising:
selecting a first entity from a first knowledge graph that includes a plurality of the first entities indicating events connected by a cause-result relation based on a first input document;
generating a second knowledge graph that includes a second entity indicating each of events connected by a cause-result relation included in a second input document, that is related to the first entity, based on the selected first entity and the second input document; and
generating a third knowledge graph by connecting the first knowledge graph and the second knowledge graph.

20. An information processing device, comprising:
a memory; and
a processor coupled to the memory and configured to:
select a first entity from a first knowledge graph that includes a plurality of the first entities indicating events connected by a cause-result relation based on a first input document;
generate a second knowledge graph that includes a second entity indicating each of events connected by a cause-result relation included in a second input document, that is related to the first entity, based on the selected first entity and the second input document; and
generate a third knowledge graph by connecting the first knowledge graph and the second knowledge graph.
